(19) United States
(12) Patent Application Publication
(10) Pub. No.: US 2021/0315190 A1
(43) Pub. Date: Oct. 14, 2021

(54) Split Collar Hook Holder

(71) Applicant: Michael Aguilar, Simi Valley, CA (US)

(72) Inventor: Michael Aguilar, Simi Valley, CA (US)

(21) Appl. No.: 17/228,530

(22) Filed: Apr. 12, 2021

Related U.S. Application Data
(60) Provisional application No. 63/008,338, filed on Apr. 10, 2020.

(51) Int. Cl. A01K 97/06

(52) U.S. Cl. CPC A01K 97/06

(57) ABSTRACT

A split collar hook holder is designed to hold a loose fishing line's hooked end in a fixed position while the fishing rod is not in use. The split collar hook holder has a has a multicomponent collar a bracket connection system, a mounting hole, and at least one first hook-receiving receptacle. The multicomponent collar has a pair of brackets that are clamped around the fishing rod by the bracket connection system. The hook-receiving receptacle traverses into the brackets and acts as the holder for the hook while the hook is not in use.

The current application claims a priority to the U.S. Provisional Patent application Ser. No. 63/008,338 filed on Apr. 10, 2020. The current application is filed on Apr. 12, 2021 while Apr. 10, 2021 was on a weekend.

### FIELD OF THE INVENTION

The present invention relates generally to fishing rod accessories. More specifically, the present invention provides a method of securely holding the hooked end of a fishing line against a fishing rod during storage and transport.

### BACKGROUND OF THE INVENTION

When it comes to fishing, it is important to keep the hook secured when transporting a fishing rod. One problem for many anglers is what to do with the hooked end of a fishing line when transporting the rod while not in use. The loose hook or lure can damage to the fishing rod or gouge individuals in the surrounding area. When transporting a fishing rod from location to location, having a loose hook or lure can be dangerous as the hook may unintendedly pierce people or objects. Another issue arises when fishing rods are unattended and not in use, the loose hook or lure of the fishing rod creates a hazardous environment. For example, after the angler reels in the hook and realizes their hook has lost its bait, the angler may leave the fishing rod unattended to obtain bait. In this example, a loose hook is hard to see and anyone around the fishing rod may not see it and walk or step into the loose hook, cause potential damage. On a charter boat, which generally has limited space due to the amount of anglers, a loose hook or lure can create a dangerous situation as well. Additionally, if the fishing line and hook is not secured, the hook can pierce, upbraid, or damage the fishing line.

The present invention addresses the above-described issues by providing a retention collar that holds the loose hook in place. Thus, preventing damage to the surrounding area.

By placing hooks and lures in an elongated groove of the hook holder, the user will not damage the fishing rod (cosmetic damage), fishing guides or more so the user hook will not hit the fishing line making the fishing line weak or susceptible to breaking.

Lastly, fishing rods can be hard to grip when reeling in larger fish because of the heavy pull done by the fish. The hook holder essentially provides the angler with an additional advantage when reeling a catch: by placing the rod over a surface (i.e. the boat rail) and securing the rod with the hook holder as a stopper creating a pivot point where the angler can get leverage. This allows the angler better control of the rod during a catch.

An objective of the present invention is to provide anglers an easy and efficient way of transporting fishing rods from location to location. Another objective of the present invention is to ensure safety of fishing rods not in use along with unattended fishing rods. Furthermore, it is the present invention's objective to provide the user an assisted grip to help the user manage and maintain the handle of the fishing rod along with assistance to reel in anything caught on the fishing rod.

### BRIEF DESCRIPTION OF THE DRAWINGS

FIG. 1 is an exploded perspective view of the present invention.

FIG. 2 is a perspective view of the present invention.

FIG. 3 is an exploded top view of the present invention.

FIG. 4 is a top view of the present invention.

FIG. 5 is right-side view of the present invention.

FIG. 6 is a top view of an embodiment of the present invention where the two brackets are connected via an adjustment member.

FIG. 7 is a perspective view of the present invention while attached to a fishing rod.

### DETAIL DESCRIPTIONS OF THE INVENTION

All illustrations of the drawings are for the purpose of describing selected versions of the present invention and are not intended to limit the scope of the present invention.

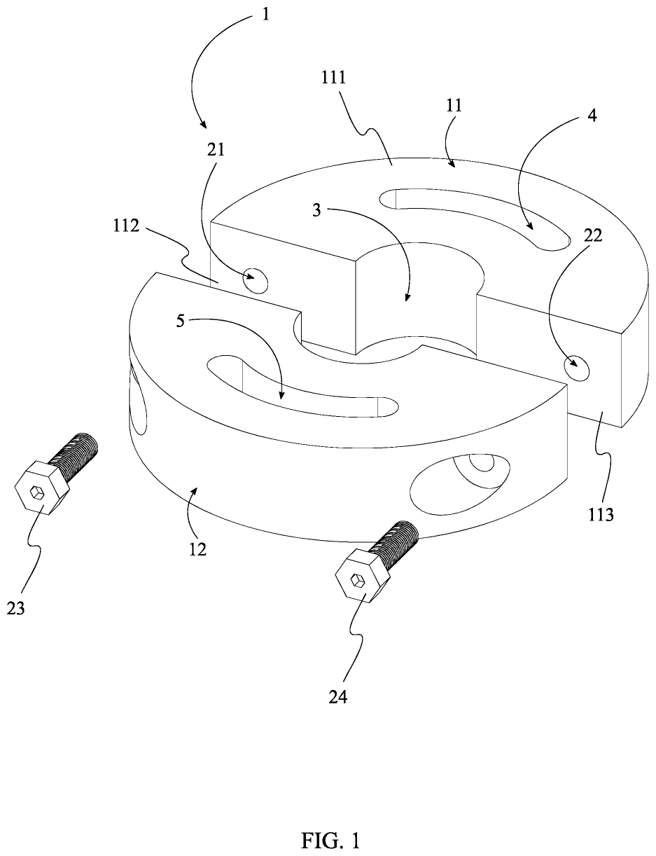

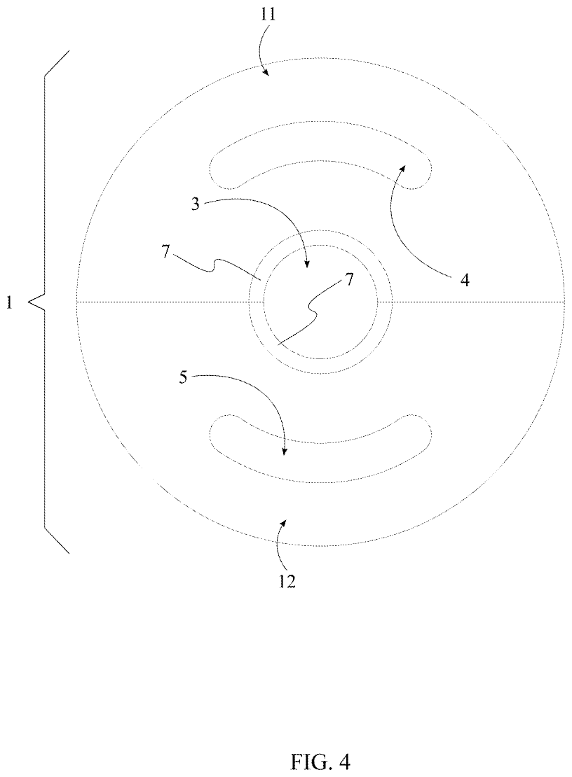

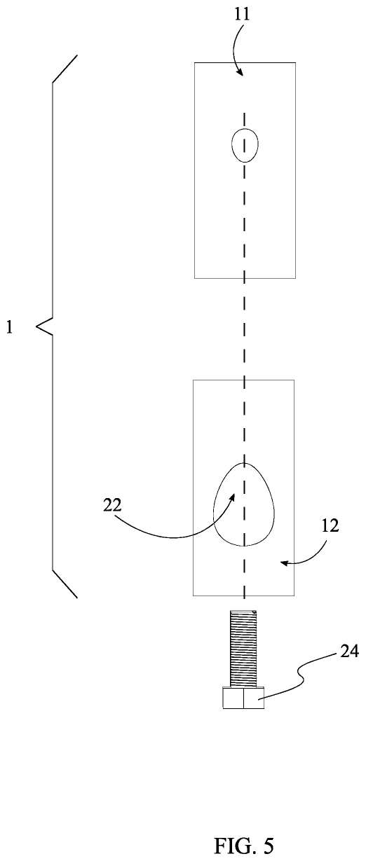

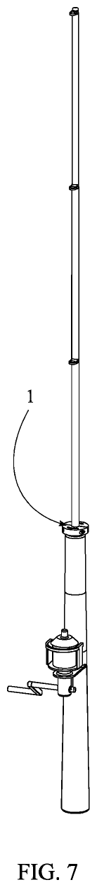

Referring to FIG. 1 through FIG. 7, the present invention, a split collar hook holder, is a device that clamps around a fishing rod and is used to retain an attached fishing hook in a stored position while the fishing rod is not in use. The present invention provides a receptacle into which the sharp end of the fishing hook can be inserted while not in use. Tension in a fishing line tethered between the fishing rod and the hook retains the sharp end of the hook within the receptacle provided by the present invention. Once the hook is inserted into the receptacle, the fishing rod becomes a benign tool incapable of hooking onto external objects.

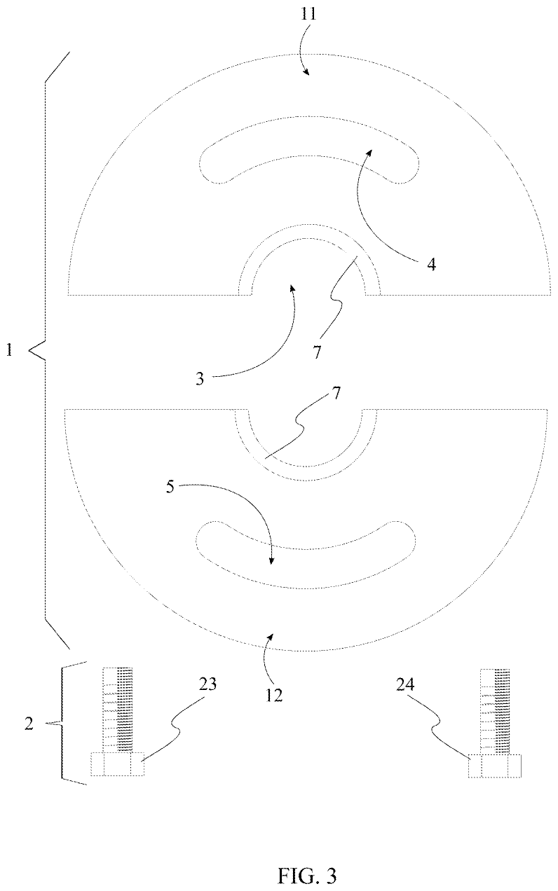

Referring to FIG. 3, to achieve the above-described functionality, the present invention comprises a multicomponent collar 1, a bracket connection system 2, a mounting hole 3, and at least one first hook-receiving receptacle 4. The multicomponent collar 1 defines the jaws of a clamp that is mounted around the fishing rod. Accordingly, the multicomponent collar 1 comprises at least one first bracket 11 and at least one second bracket 12, where the first bracket 11 is the first jaw and the second bracket 12 is the second jaw. The bracket connection system 2 is a fastening assembly that is used to attach the first bracket 11 to the second bracket 12. Specifically, the bracket connection system 2 is engaged between the first bracket 11 and the second bracket 12. As a result, the bracket connection system 2 provides the clamping force required to secure the first bracket 11 and the second bracket 12 around the fishing rod's lateral sidewall. The mounting hole 3 normally traverses through the first bracket 11 and the second bracket 12 to form an opening, within which the fishing rod rests when the first bracket 11 and the second bracket 12 are clamped together.

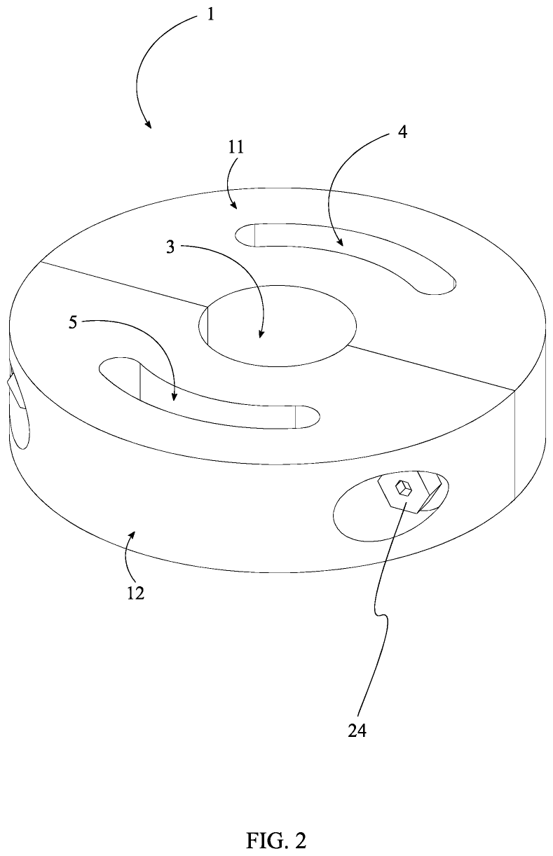

Referring to FIG. 2, the first hook-receiving receptacle 4 traverses into the first bracket 11 and is positioned offset from the mounting hole 3, across the first bracket 11. Thus positioned, the first hook-receiving receptacle 4 is able to retain the hook while the fishing rod is not in use. A supplemental embodiment comprises at least one second hook-receiving receptacle 5 that traverses into the second bracket 12 and is positioned offset from the mounting hole 3 across the second bracket 12. Thus, a user is given options to retain the hook in a desired orientation while not in use. In some embodiments, the first hook-receiving receptacle 4 and the second hook receiving receptacle traverse completely through the brackets of the multicomponent collar 1 to enable the present invention to be used with hooks of varying shape and size. In further embodiments, a plurality of first hook-receiving receptacles 4 traverses through the first bracket 11 and a plurality of second hook-receiving receptacles 5 traverses through the second bracket 12 so that the user has multiple options when storing the hook. In yet further embodiments, the first hook-receiving receptacle 4 and the second hook-receiving receptacle are semicircular in shape.

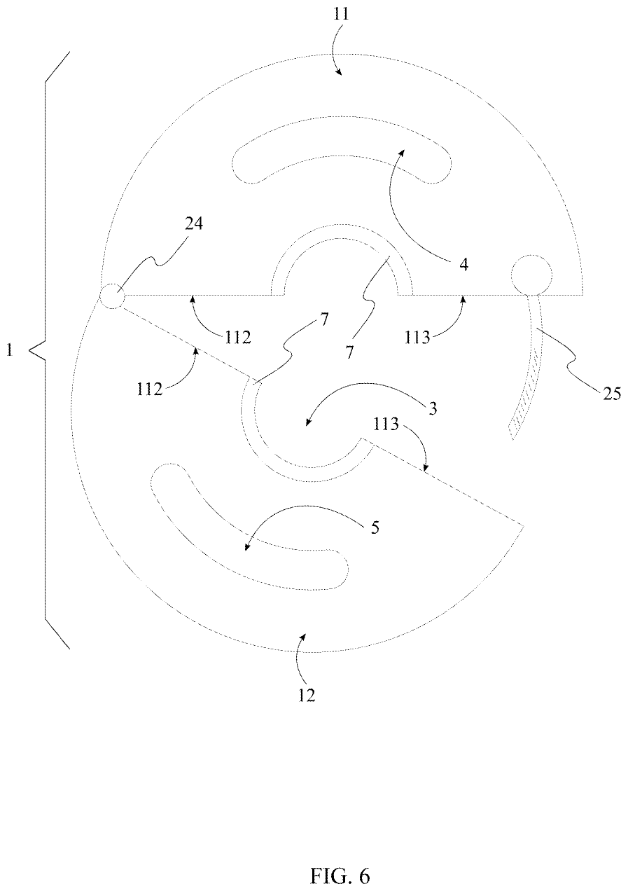

Referring to FIG. 1 and FIG. 6, the first bracket 11 and the second bracket 12 function as opposing clamping jaws where the arrangement of components in the first bracket 11 is mirrored in the second bracket 12. As such, the first bracket 11 and the second bracket 12 each comprise a bracket body 111, a first fastening plate 112 and a second fastening plate 113. The first fastening plate 112 and the second fastening plate 113 form corresponding mating components that are forced together when the present invention is clamped around the fishing rod. The first fastening plate 112 is laterally attached to the bracket body 111, the second fastening plate 113 is laterally attached to the bracket body 111, and the mounting hole 3 is positioned in between the first fastening plate 112 and the second fastening plate 113. Thus positioned, the first fastening plate 112 of the first bracket 11 is intended to abut the first fastening plate 112 of the second bracket 12 when the multicomponent collar 1 is clamped around the fishing rod. Similarly, the second fastening plate 113 of the first bracket 11 is intended to abut the second fastening plate 113 of the second bracket 12 when the multicomponent collar 1 is clamped around the fishing rod. Preferably, the bracket connection system 2 is intended to drive the first fastening plate 112 and the second fastening plate 113 of the first bracket 11 and the second bracket 12 toward each other. Further, because the fastening plates are positioned on opposite sides of the mounting hole 3, the clamping force is evenly distributed around the lateral sidewall of the fishing rod.

Referring to FIG. 1 and FIG. 3, to facilitate the aforementioned clamping functionality, the bracket connection system 2 comprises at least one first fastening hole 21, at least one second fastening hole 22, at least one first fastener 23, and at least one second fastener 24. The first fastening hole 21 normally traverses through the first fastening plate 112 and the bracket body 111. Similarly, the second fastening hole 22 normally traverses through the second fastening plate 113 and the bracket body 111. Thus positioned, the first fastening hole 21 and the second fastening hole 22 enable the bracket connection system 2 to be engaged into the first fastening hole 21 of the first bracket 11, the first fastening hole 21 of the second bracket 12, the second fastening hole 22 of the first bracket 11, and the second fastening hole 22 of the second bracket 12. The first fastener 23 is engaged into the first fastening hole 21 and the second fastener 24 is engaged into the second fastening hole 22. Consequently, the user is able to force the first bracket 11 toward the second bracket 12 by actuating the first fastener 23 within the first fastening hole 21 and the second fastener 24 within the second fastening hole 22.

Referring to FIG. 1 and FIG. 6, in some embodiments, the bracket connection system 2 comprises at least one first width-adjustment mechanism 25 and at least one second width-adjustment mechanism 26. The first width-adjustment mechanism 25 and the second width-adjustment mechanism 26 are clamps that are designed to augment or replace the first fastener 23 and the second fastener 24. Specifically, the first width adjustment mechanism is connected in between the first fastening plate 112 of the first bracket 11 and the first fastening plate 112 of the second bracket 12. Likewise, the second width adjustment mechanism is connected in between the second fastening plate 113 of the first bracket 11 and the second fastening plate 113 of the second bracket 12. Preferably, the multicomponent collar 1 can be clamped onto areas of the fishing rod that have varying diameter. In some embodiments the first width-adjustment mechanism 25 and the second width-adjustment mechanism 26 are hose clamps. In alternative embodiments the first bracket 11 and the second bracket 12 include flexible straps that are fed into the first width-adjustment mechanism 25 and the second adjustment mechanism. The user is able to tighten the straps around the fishing rod by manipulating the first width-adjustment mechanism 25 and the second adjustment mechanism.

Referring to FIG. 1 through FIG. 7, referring to FIG. 1 through FIG. 7, the present invention further comprises a clamping grommet 7 and a friction-reducing liner 6. The clamping grommet 7 is laterally mounted to the multicomponent collar 1 within the mounting hole 3 to facilitate forming a secure connection between the multicomponent collar 1 and the fishing rod. Preferably the clamping grommet 7 is split into a first grommet 7 and a second grommet 7 where the first grommet 7 is mounted onto the first bracket 11 coextensive with the mounting hole 3 and the second grommet 7 is mounted onto the second bracket 12 coextensive with the mounting hole 3. Thus, the clamping grommet 7 is deformed when the first bracket 11 and the second bracket 12 are forced toward the fishing rod. This configuration prevents the present invention from marring the surface of the fishing rod. Additionally, the clamping grommet facilitates attaching the present invention to various locations along a length of the fishing rod. However, the invention is designed to intended to attach to various locations along the fishing rod without the use of the grommet. The friction-reducing liner 6 is superimposed onto the multicomponent collar 1 so that the present invention does not introduce drag along the fishing line.

Although the invention has been explained in relation to its preferred embodiment, it is to be understood that many other possible modifications and variations can be made without departing from the spirit and scope of the invention as hereinafter claimed.

What is claimed is:

1. A split collar hook holder comprising:
a multicomponent collar,
a bracket connection system;
a mounting hole;
at least one first hook-receiving receptacle;
the multicomponent collar comprising at least one first bracket and at least one second bracket;
the bracket connection system being engaged between the first bracket and the second bracket;
the mounting hole normally traversing through the first bracket and the second bracket;
the first hook-receiving receptacle traversing into the first bracket; and
the first hook-receiving receptacle being positioned offset from the mounting hole, across the first bracket.

2. The split collar hook holder as claimed in claim 1 comprising:
the first bracket and the second bracket each comprising a bracket body, a first fastening plate, and a second fastening plate;
the first fastening plate being laterally attached to the bracket body;
the second fastening plate being laterally attached to the bracket body; and
the mounting hole being positioned in between the first fastening plate and the second fastening plate.

3. The split collar hook holder as claimed in claim 2 comprising:
at least one first fastener hole;
the first fastening hole normally traversing through the first fastening plate and the bracket body; and
the bracket connection system engaging into the first fastening hole of the first bracket and the first fastening hole of the second bracket.

4. The split collar hook holder as claimed in claim 2 comprising:
at least one second fastener hole;
the second fastening hole normally traversing through the second fastening plate and the bracket body; and
the bracket connection system engaging into the second fastening hole of the first bracket and the second fastening hole of the second bracket.

5. The split collar hook holder as claimed in claim 1 comprising:
the bracket connection system comprising at least one first fastener hole, at least one second fastener hole, at least one first fastener, and at least one second fastener;
the first fastening hole laterally traversing through the first bracket and the second bracket;
the second fastening hole laterally traversing through the first bracket and the second bracket;
the mounting hole being positioned in between the first fastening hole and the second fastening hole;
the first fastener engaging into the first fastener hole; and
the second fastener engaging into the second fastening hole.

6. The split collar hook holder as claimed in claim 1 comprising:
the bracket connection system comprising at least one first width-adjustment mechanism, at least one second width-adjustment mechanism;
the first width adjustment mechanism being connected in between the first bracket and the second bracket;
the second width adjustment mechanism being connected in between the first bracket and the second bracket; and
the mounting hole being positioned in between the first width adjustment mechanism and the second width adjustment mechanism.

7. The split collar hook holder as claimed in claim 1 comprising:
a clamping grommet; and
the clamping grommet being laterally mounted to the multicomponent collar within the mounting hole.

8. The split collar hook holder as claimed in claim 1 comprising:
at least one second hook-receiving receptacle;
the second hook-receiving receptacle traversing into the second bracket; and
the second hook-receiving receptacle being positioned offset from the mounting hole, across the second bracket.

9. The split collar hook holder as claimed in claim 8 wherein the first hook-receiving receptacle and the second hook-receiving receptacle being semicircular in shape.

10. The split collar hook holder as claimed in claim 8 wherein the first hook-receiving receptacle and the second hook-receiving receptacle traversing through the multicomponent collar.

11. The split collar hook holder as claimed in claim 1 comprising:
a friction-reducing liner; and
the friction-reducing liner being superimposed onto the multicomponent collar.
